(19) United States
(12) Patent Application Publication
(10) Pub. No.: US 2016/0291347 A1
(43) Pub. Date: Oct. 6, 2016

(54) Color-coded eyeglasses identification system

(71) Applicant: Steven Siegel, Bay Harbor Islands, FL (US)

(72) Inventor: Steven Siegel, Bay Harbor Islands, FL (US)

(21) Appl. No.: 15/088,846

(22) Filed: Apr. 1, 2016

Related U.S. Application Data
(60) Provisional application No. 62/178,169, filed on Apr. 3, 2015.

(51) Int. Cl. G02C 11/00

(52) U.S. Cl. CPC G02C 11/00

(57) ABSTRACT

A color-coded eyeglasses identification system includes a plurality of identification components; at least one eyeglass frame; and a color code placard, including color code designators and designations. A color of an identification component is associated with a characteristic of an eyeglass frame, including an optical power or an owner. When an identification component is installed on an eyeglass frame, a user can identify a characteristic of the eyeglass frame by the installed identification component. Further disclosed is a color-coded eyeglasses apparatus, including an eyeglass frame and at least one identification component.

### CROSS-REFERENCE TO RELATED APPLICATIONS

This application claims the benefit of U.S. Provisional Application No. 62/178,169, filed Apr. 3, 2015.

### FIELD OF THE INVENTION

The present invention relates generally to the field of eyeglasses, and more particularly to methods and systems for color-coded identification of eyeglasses.

### BACKGROUND OF THE INVENTION

Many people use eyeglasses to correct hyperopia, often caused by age-related presbyopia. Hyperopia, also known as farsightedness, reduces the ability to see nearby objects clearly, which can affect the ability to perform close-range activities such a reading, sewing, working on computers, and watching television. Hyperopia can be addressed by a number of different methods, including eyeglasses with lenses ground to the appropriate shape.

Eyeglasses commonly used to correct farsightedness are available without prescription and are inexpensive. They are available in a variety of strengths, as measured in diopters, and are typically described as a decimal number of three digits, such as 1.50, 2.00, 2.75, etc. Users often purchase multiple eyeglasses to allow for loss or breakage of the eyeglass, misplacement of the eyeglass, convenience, and use with various tasks requiring different correction of focus of the eye. For example, a person may desire eyeglasses of high strength, such as 3.00, for reading a book, but a lower strength, such as 1.50, for watching television. Because of bulk manufacture and the inexpensive nature of these eyeglasses, frames of various individual units may be similar in appearance or identical to those of other units in the possession of an individual or a couple.

Each pair of eyeglasses are commonly manufactured with the strength imprinted on the inside of one of the temples, also known as the arms. However, the imprinted numbers are necessarily small since they must conform to the narrow shape of the temple. The wearer, being farsighted, often cannot identify the strength of the eyeglass he or she wishes to don. In addition, with wear, printed identification numbers tend to become illegible or even lost. As many eyeglass users own multiple pairs of similar-looking eyeglasses, the inability to identify a specific pair of eyeglasses can become a burden.

As such, considering the foregoing, it may be appreciated that there continues to be a need for novel and improved devices and methods for identifying eyeglasses of a specific strength quickly and reliably using an unobtrusive visual aid.

### SUMMARY OF THE INVENTION

The foregoing needs are met, to a great extent, by the present invention, wherein in aspects of this invention, enhancements are provided to the existing model of eyeglasses identification for farsighted people.

In an aspect, a color-coded eyeglasses identification system can include:
a) a plurality of identification components, wherein each of the plurality of identification components comprises one of a plurality of colors; and
b) at least one eyeglass frame, further comprising at least one eyeglass lens, wherein at least one of the plurality of identification components is configured to be installed on the at least one eyeglass frame.

In related aspects, the color-coded eyeglasses identification system can further include a color code placard comprising a plurality of color code designators and a plurality of color code designations.

In related aspects, the color of each of the identification components corresponds with a color code designator, and each color code designation represents a characteristic of the at least one eyeglass frame, such that the color-coded eyeglasses identification system is configured to enable a user to identify a characteristic of the at least one eyeglass frame by an installed identification component.

In an aspect, a color-coded eyeglasses apparatus can include:
a) at least one identification component, wherein the at least one identification component comprises one of a plurality of colors; and
b) an eyeglass frame, further comprising at least one eyeglass lens, wherein at least one identification component is configured to be installed on the eyeglass frame.

In related aspects, the color code designators can be associated with an optical power of an eyeglass lens.

In related aspects, the identification components can be made from an elastic and resilient material, such as a rubber material, including synthetic and natural rubber.

In related aspects, the identification components can be shaped as loops, such as rubber bands and hollow cylinders.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates a color-coded eyeglasses identification system, according to an embodiment of the invention.

FIG. 2 illustrates a perspective view of an identification component, according to an embodiment of the invention.

FIG. 3 illustrates a side view of an identification component, according to an embodiment of the invention.

FIG. 4 illustrates a side view of an eyeglass frame and an identification component, according to an embodiment of the invention.

FIG. 5 illustrates a side view of an identification component installed on eyeglasses, according to an embodiment of the invention.

FIG. 6 illustrates a side view of an identification component installed on eyeglasses, according to an embodiment of the invention.

FIG. 7 illustrates a side view of an identification component installed on eyeglasses, according to an embodiment of the invention.

FIG. 8 illustrates a front view of color code placard, according to an embodiment of the invention.

FIG. 9 illustrates a rear view of color code placard, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

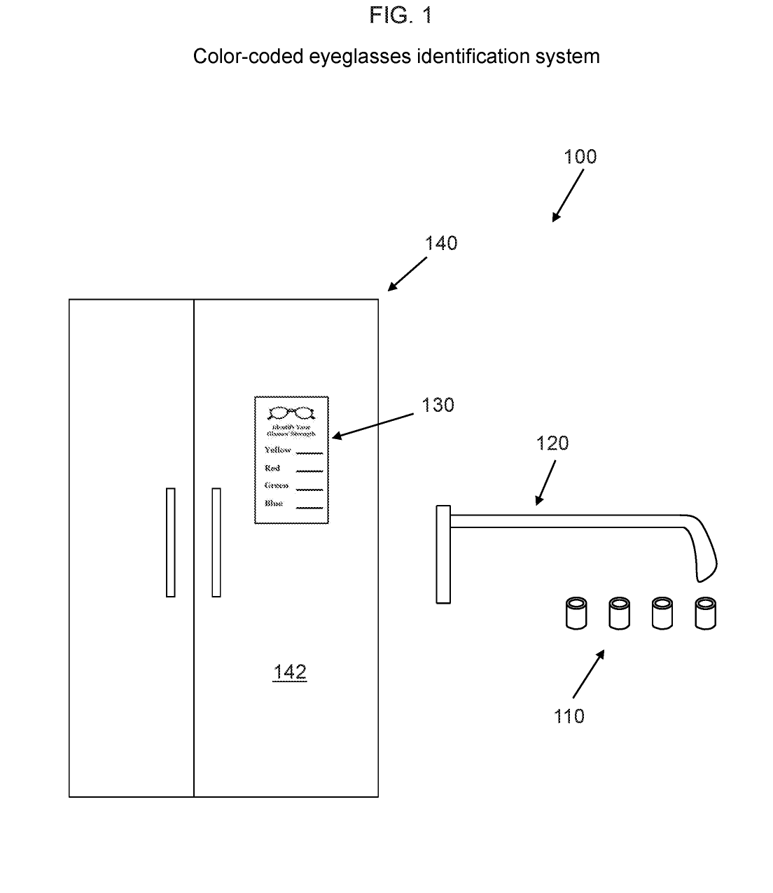

In the following, we describe the structure of an embodiment of a color-coded eyeglasses identification system 100 with reference to FIG. 1, in such manner that like reference numerals refer to like components throughout; a convention that we shall employ for the remainder of this specification.

In a related embodiment, as shown in FIG. 1, a color-coded eyeglasses identification system 100 can include:
a) a plurality of identification components 110;
b) at least one eyeglass frame 120; and
c) a color code placard 130.

In a related embodiment, as shown in FIG. 1, each identification component 110 of the plurality of identification components 110 comprises a color. In certain embodiments, the color of each identification component 110 can be unique with respect to the plurality of identification components 110. In other embodiments, the colors of the identification components 110 can be recurring such that more than one of the plurality of identification components 110 share the same color.

In a related embodiment, an identification component 110 may comprise more than one color, including two, three, or more colors.

In a related embodiment, as shown in FIG. 1, the color code placard 130 can be situated on a surface such that it is approximately eye-level with a user and thereby easily viewable. For example, the color code placard 130 can be situated on a door 142 of a refrigerator 140 by methods well-known in the art, such as a magnet or a clip.

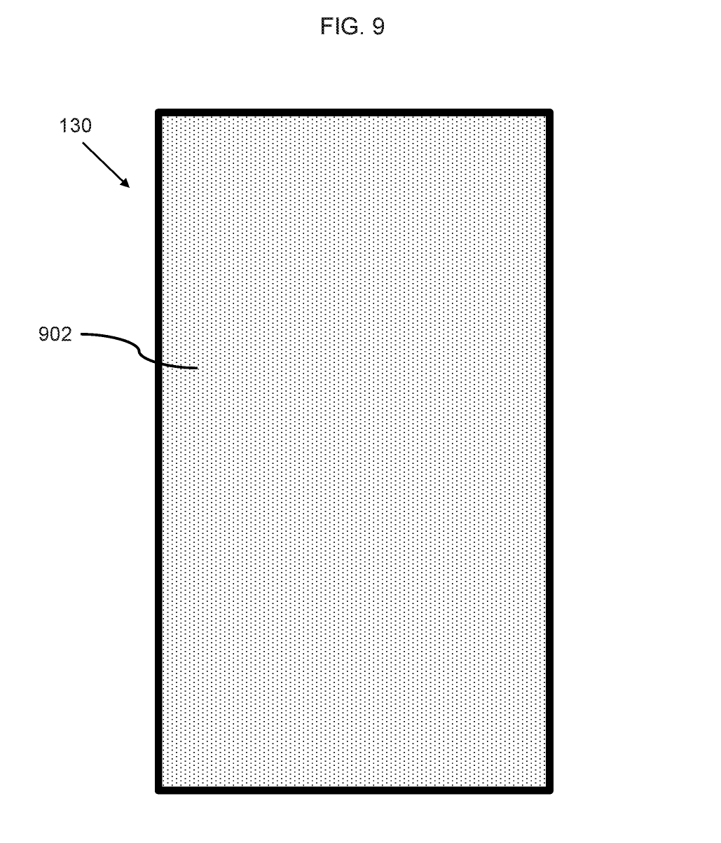

In a further related embodiment, as shown in FIG. 9, the color code placard 130 can be configured such that a rear side 902 of the color code placard 130 is magnetized, such that the color code placard 130 includes at least one or a plurality of magnets, whereby the color code placard 130 for example can be configured as a refrigerator magnet, manufacture according to well-known methods, whereby the color code placard 130 can be configured to be mounted on a refrigerator 140.

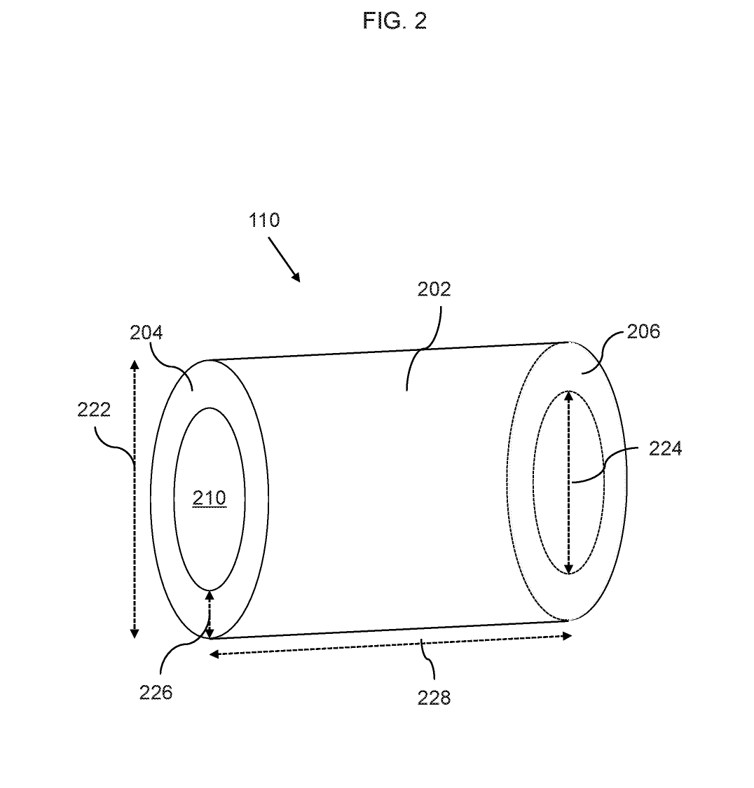

In a related embodiment, FIG. 2 shows a perspective view of an identification component 110.

In a related embodiment, as shown in FIG. 2, an identification component 110 can be configured as a hollow cylinder defined by an outer surface 202 and an inner surface 210. The identification component further comprises a first end surface 204 and a second end surface 206.

In a related embodiment, a color of an identification component 110 can be defined by a color of at least one of the outer surface 202, the first end surface 204, and the second end surface 206.

In a related embodiment, as shown in FIG. 2, the identification component 110 can have an outer diameter 222, an inner diameter 224, a wall thickness 226, and a length 228, configured such that the identification component 110 can be installed on an eyeglass frame 120.

In a related embodiment, the identification component 110 can be configured with a length 228 in a range of 1-15 mm.

In a related embodiment, the identification component 110 can be configured with an inner diameter 224 in a range of 2-10 mm.

In a related embodiment, the identification component 110 can be configured with an outer diameter 222 in a range of 2-15 mm.

In a related embodiment, the identification component 110 can have an outer diameter 222 of substantially 0.3125″, an inner diameter 224 of substantially 0.1875″, a wall thickness 226 of substantially 0.0625″, and a length 228 of substantially 0.25″.

In a related embodiment, the identification component 110 can have an outer diameter 222 of substantially 0.25″, an inner diameter 224 of substantially 0.15625″, a wall thickness 226 of substantially 0.046875″, and a length 228 of substantially 0.25″.

In a related embodiment, the length 228 of the identification component 110 can be substantially smaller than the outer diameter 222, such that the identification component 110 can be configured as a loop or toroidal structure, such as a small rubber band.

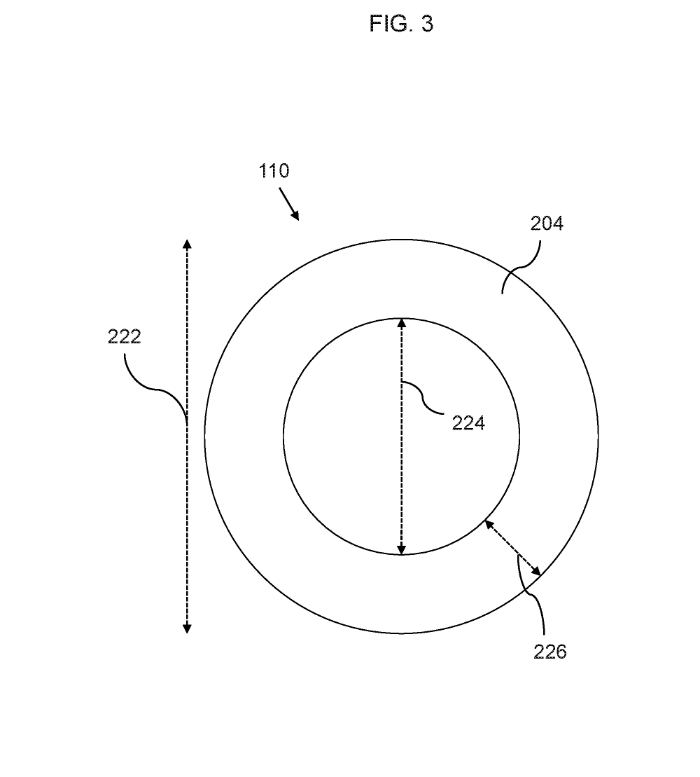

In a related embodiment, FIG. 3 shows a side view of an identification component 110.

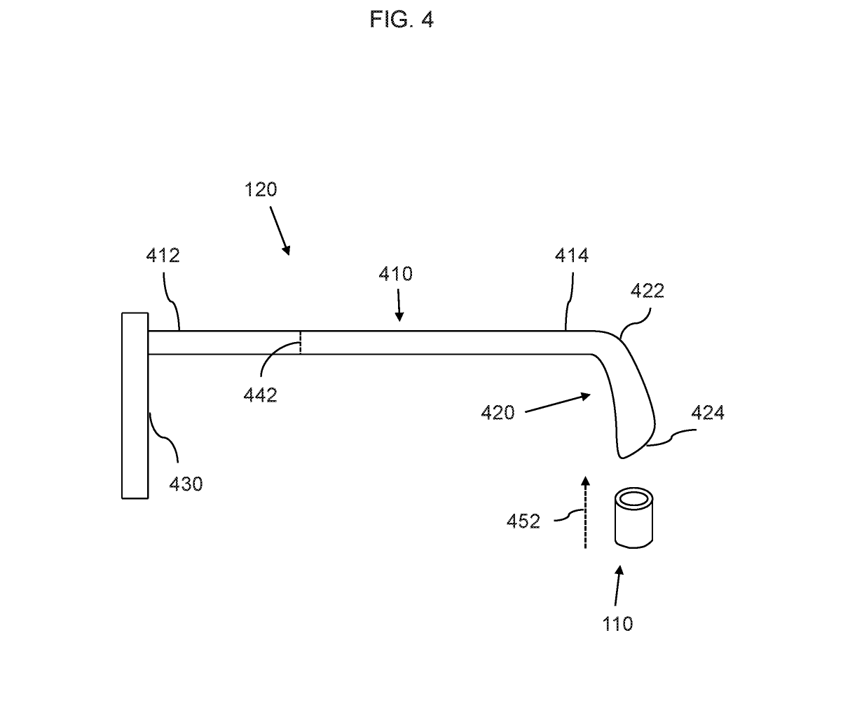

In related embodiments, FIGS. 4-7 show a side view of an eyeglass frame 120.

In a related embodiment, as shown in FIG. 4, the eyeglass frame 120 can include at least one temple section 410 having a proximal temple end 412 and a distal temple end 414. The proximal temple end 412 is located adjacent to a lens component 430, and the distal temple end 414 is located adjacent to an earpiece section 420. The earpiece section 420 can include a proximal earpiece end 422 adjacent to the distal temple end 414, and a distal earpiece end 424.

In a related embodiment, as shown in FIG. 4, a temple section 410 can have a temple width 442.

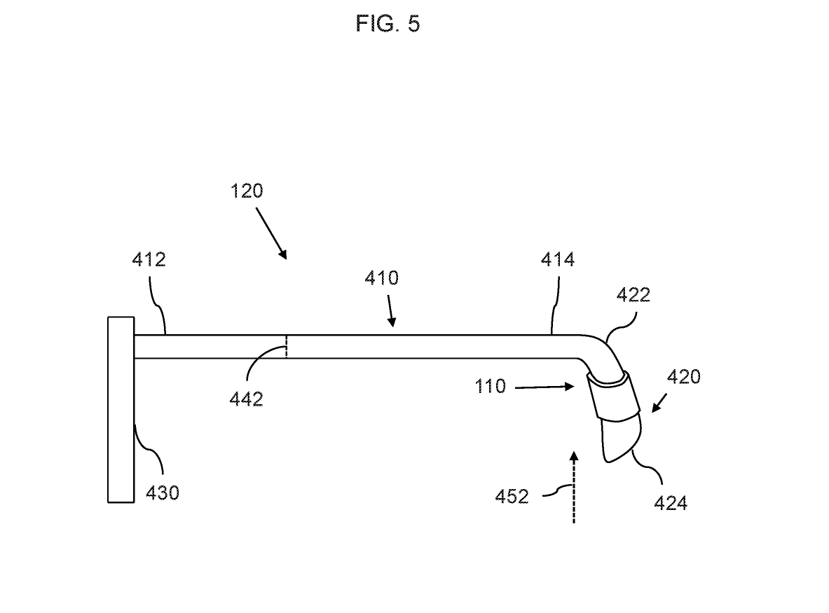

In a related embodiment, as shown in FIGS. 4 and 5, an identification component 110 can be installed on an eyeglass frame 120 by situating the identification component 110 at the distal earpiece end 424 and pushing the identification component 110 up the earpiece section 420 in a direction 452 towards the proximal earpiece end 422.

In a related embodiment, as shown in FIG. 5, the identification component 110 can be made out of a flexible material, such that the identification component 110 can resiliently conform to the contours of the earpiece section 420 as the identification component 110 is moved from the distal earpiece end 424 to the proximal earpiece end 422.

In related embodiments, the identification component 110 can be made from an elastic and resilient material, such as a rubber material, including synthetic and natural rubber.

In a further related embodiment, the identification component 110 can be configured as a small tube segment, that can be cut from a longer piece of a tube, which for example can be made from an elastic and resilient rubber or latex tube.

In a related embodiment, as shown in FIG. 5, the identification component 110 can be situated on the earpiece section 420 at the proximal earpiece end 422, the distal earpiece end 424, or between the proximal and distal earpiece ends 422 424.

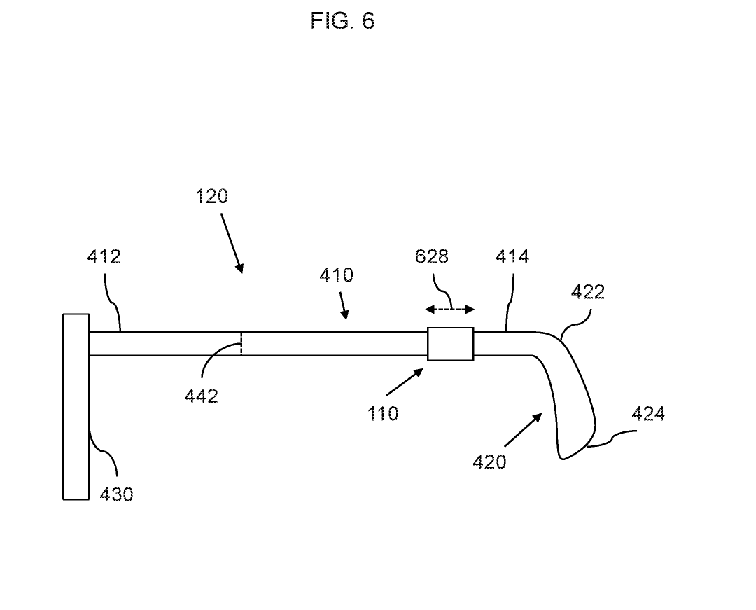

In a related embodiment, as shown in FIG. 6, the identification component 110 can be situated on the temple section 410 at the proximal temple end 412, the distal temple end 414, or between the proximal and distal temple ends 412 414.

In a related embodiment, as shown in FIG. 6, the eyeglass frame 120 can be configured such that the temple width 442 is approximately equal to the inner diameter 224 of an identification component 110, whereby the length 628 of the installed identification component 110 is approximately equal to the length 228 of the uninstalled identification component 110, as shown in FIG. 2.

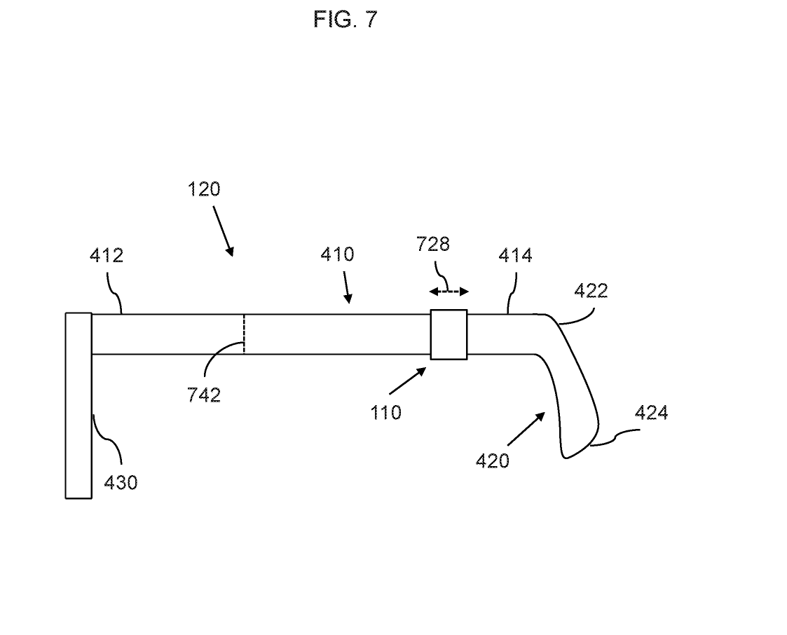

In a related embodiment, as shown in FIG. 7, the eyeglass frame 120 can be configured such that the temple width 742 is greater that the inner diameter 224. The installed identification component 110 can be configured to resiliently conform to the shape of the temple section 410 such that the length 728 of the installed identification component 110 is less than the length 228 of the uninstalled identification component 110, as shown in FIG. 2.

In a related embodiment, more than one identification component 110 can be situated on an eyeglass frame 120. In certain embodiments, two identification components 110 can be situated on a temple section 410. In other embodiments, an eyeglass frame 120 can be configured with two temple sections 410 such that an identification component 110 can be installed on each temple section 410.

In a related embodiment, the identification component 110 can be configured to be reversible, such that the inner surface 210 can become the outer surface 202 and the outer surface 202 can become the inner surface 210 when the second end surface 206 is folded past the first end surface 204 or vice versa. This configuration can allow the identification component 110 to be moved up the earpiece section 420 or across the temple section 410 by reversibly folding over itself.

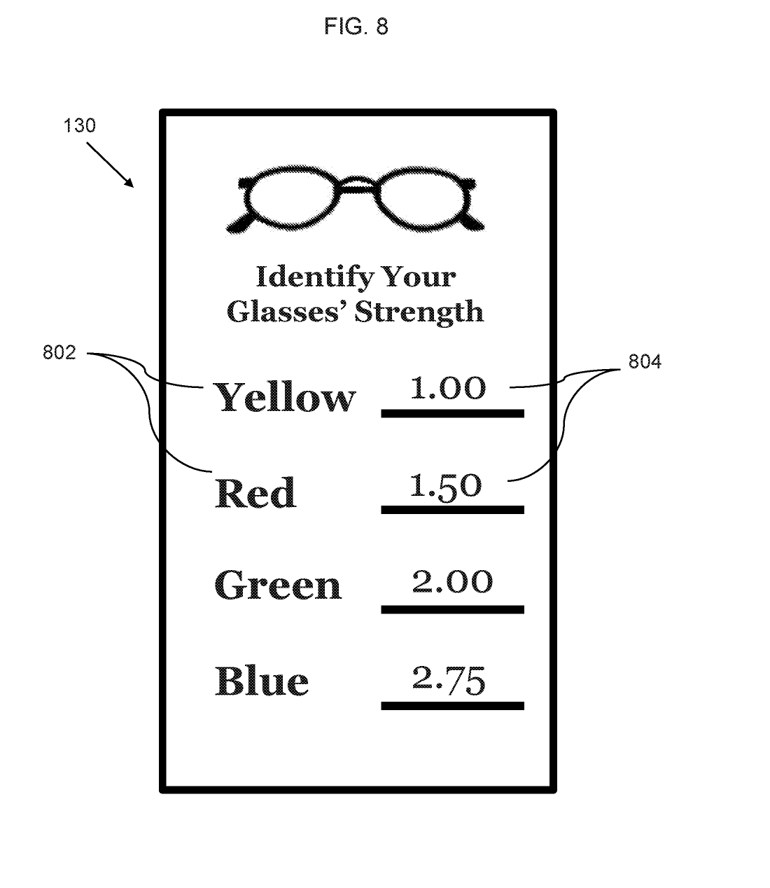

In a related embodiment, FIG. 8 shows a color code placard 130.

In a related embodiment, as shown in FIG. 8, the color code placard 130 can include a plurality of color code designators 802, wherein each color code designator 802 is associated with a different color. In certain embodiments, each color code designator 802 can be the name of a color, wherein the name can optionally be displayed in the same color, i.e. the color code designator 802 “Yellow” can be displayed on the color code placard 130 in a yellow type. In other embodiments, each color code designator 802 can be configured as a colored shape, such as a yellow rectangle.

In a related embodiment, as shown in FIG. 8, the color code placard 130 can further include a plurality of color code designations 804, wherein each color code designation 804 corresponds to an adjacent color code designator 802.

In a related embodiment, as shown in FIG. 8, each color code designation 804 can represent an optical power of an eyeglass lens of the eyeglass frame 120 as measured in diopters, such as 1.25, 2.75, etc. Furthermore, the plurality of color code designations 804 can more generally represent whether an eyeglass frame 120 includes prescription or non-prescription eyeglass lenses.

In a related embodiment, each color code designation 804 can represent an owner of an eyeglass frame 120, such that a plurality of eyeglass frames 120 with installed identification components 110 can be easily identified by their owners by the color of the identification components 110.

In a related embodiment, each color code designator 802 can be associated with more than one color, including two, three, or more colors.

In an embodiment, a color-coded eyeglasses identification system 100 can include:
a) a plurality of identification components 110, wherein each of the plurality of identification components 110 includes one of a plurality of colors;
b) at least one eyeglass frame 120, further comprising at least one eyeglass lens, wherein at least one of the plurality of identification components 110 can be installed on the at least one eyeglass frame 120.

In a related embodiment, a color-coded eyeglasses identification system 100 can further include a color code placard 130, including:
a) a plurality of color code designators 802; and
b) a plurality of color code designations 804, wherein each color code designation 804 is associated with an adjacent color code designator 802;
wherein the color of each of the identification components 110 corresponds with a color code designator 802;
wherein each color code designation 804 represents a characteristic of the eyeglass frame 120;
whereby the color-coded eyeglasses identification system 100 is configured to enable a user to identify the characteristic of the eyeglass frame 120 by an installed identification component 110.

In an embodiment, a color-coded eyeglasses apparatus can include:
a) at least one identification component 110, wherein the at least one identification component 110 comprises one of a plurality of colors; and
b) an eyeglass frame 120, further comprising at least one eyeglass lens, wherein at least one identification component 110 is configured to be installed on the eyeglass frame 120.

In a related embodiment, an installed identification component 110 can be configured to have a negligible effect on the basic functioning of an eyeglass frame 120. Furthermore, the identification component 110 can be configured to have a limited effect on the overall appearance of an eyeglass frame 120 when worn.

In a related embodiment, an installed identification component 120 can be configured such that the color of the identification component 110 is easily viewable by a farsighted person.

In a related embodiment, an identification component 110 can be easily installed on and removed from an eyeglass frame 120.

Here has thus been described a multitude of embodiments of the color-coded eyeglasses identification system, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A color-coded eyeglasses identification system, comprising:
a) a plurality of identification components, wherein each of the plurality of identification components comprises one of a plurality of colors; and
b) at least one eyeglass frame, further comprising at least one eyeglass lens, wherein at least one of the plurality of identification components is configured to be installed on the at least one eyeglass frame.

2. The color-coded eyeglasses identification system of claim 1, further comprising a color code placard, the color code placard comprising:
a) a plurality of color code designators; and
b) a plurality of color code designations, wherein each color code designation is associated with an adjacent color code designator;
wherein the color of each of the identification components corresponds with a color code designator;
wherein each color code designation represents a characteristic of the at least one eyeglass frame;
whereby the color-coded eyeglasses identification system is configured to enable a user to identify the characteristic of the at least one eyeglass frame by an installed identification component.

3. The color-coded eyeglasses identification system of claim 1, wherein the plurality of identification components are configured as loops.

4. The color-coded eyeglasses identification system of claim 3, wherein the plurality of identification components are configured as rubber bands.

5. The color-coded eyeglasses identification system of claim 3, wherein the plurality of identification components each are configured to be a hollow cylinder.

6. The color-coded eyeglasses identification system of claim 2, wherein each color code designation represents an optical power of the at least one eyeglass lens.

7. The color-coded eyeglasses identification system of claim 2, wherein each color code designation represents an owner of the at least one eyeglass frame.

8. The color-coded eyeglasses identification system of claim 1, wherein the plurality of identification components are made from a rubber material.

9. The color-coded eyeglasses identification system of claim 1, wherein the plurality of identification components are made from an elastic and resilient material.

10. The color-coded eyeglasses identification system of claim 1, wherein each identification component in the plurality of identification components is configured with a length in a range of 1-15 mm.

11. The color-coded eyeglasses identification system of claim 1, wherein each identification component in the plurality of identification components is configured with an inner diameter in a range of 2-10 mm.

12. The color-coded eyeglasses identification system of claim 2, wherein a rear side of the color code placard is magnetized.

13. A color-coded eyeglasses apparatus, comprising:
a) at least one identification component, wherein the at least one identification component comprises one of a plurality of colors; and
b) an eyeglass frame, further comprising at least one eyeglass lens, wherein the at least one identification component is installed on the eyeglass frame.

14. The color-coded eyeglasses apparatus of claim 13, wherein the at least one identification component is configured as a loop.

15. The color-coded eyeglasses apparatus of claim 14, wherein the at least one identification component is configured to be cylindrical.

16. The color-coded eyeglasses apparatus of claim 13, wherein a color of the at least one identification component is configured to be associated with an optical power of the at least one eyeglass lens.

17. The color-coded eyeglasses apparatus of claim 13, wherein a color of the at least one identification component is configured to be associated with an owner of the at least one eyeglass frame.

18. The color-coded eyeglasses apparatus of claim 13, wherein the at least one identification component is made from a rubber material.

19. The color-coded eyeglasses apparatus of claim 13, wherein the at least one identification component is configured with a length in a range of 1-15 mm.

20. The color-coded eyeglasses apparatus of claim 13, wherein the at least one identification component is configured with an inner diameter in a range of 2-10 mm.
